(19) United States
(12) Patent Application Publication
(10) Pub. No.: US 2013/0120317 A1
(43) Pub. Date: May 16, 2013

(54) CONTROL DEVICE OF A MULTI-FUNCTIONAL SYSTEM FOR MOTOR VEHICLES

(71) Applicant: Visteon Global Technologies, Inc., Van Buren Township, MI (US)

(72) Inventors: Henk Hendriks, Baexem (NL); Andreas Rode, Kerpen (DE); Rainer Heers, Koln (DE); Stefan Reinders, Kall-Scheven (DE); Frank Tylinski, Elsdorf (DE); Mario Wirtz, Koln (DE)

(73) Assignee: VISTEON GLOBAL TECHNOLOGIES, INC., Van Buren Township, MI (US)

(21) Appl. No.: 13/663,997

(22) Filed: Oct. 30, 2012

(30) Foreign Application Priority Data
Nov. 14, 2011 (DE) 10 2011 055 319.3

(51) Int. Cl. G06F 3/042

(52) U.S. Cl. 345/175

(57) ABSTRACT

A control device of a multi-functional system for motor vehicles is provided. The control device may include a movable and touch-sensitive control element, an input unit electrically insulated from the control element, the input unit including a set of optical sensors adapted to detect at least one of motion of or touch action on the control element, a display unit adapted to represent information in list form with the information associated with control of the multi-functional system, a computing unit in data connection with the input unit and the display unit, the computing unit adapted to convert positional data associated with the control element or touch action on the control element into a corresponding position in a selection list of the display unit, and an actuatable switching unit coupled to the control element with the switching unit allowing selection of a list element.

### RELATED APPLICATIONS

The present application claims the benefit of co-pending German Patent Application No. DE 10 2011 055 319.3, filed Nov. 14, 2011, the contents of which are incorporated herein by reference.

### FIELD OF THE INVENTION

The present invention generally relates to a control device of a multi-functional system for motor vehicles.

### BACKGROUND

In various vehicles, roller-shaped control elements or control knobs/rotary actuators, rotary-pressing actuators, 4- or 8-path rotary-pressing actuators, joysticks or other control elements and control units formed thereof are employed to control multi-functional systems, preferably through steering-wheel control elements.

To control multi-functional systems through information represented on a display in menus or similar structures requires specific consideration in the design and concept of control elements.

Purely mechanical control elements electrically connected as usual meet the requirements of the car manufacturers to some extent only, particularly with respect to watertight sealing or water-insensitive design.

In DE 101 23 478 A1 a bi-directional control element shaped as a roller is described. The roller is rotatable and pressable. Another configuration of the roller is described as being equipped with two switches arranged laterally.

From US 2008/257701 A a roller-shaped control element is known. The roller is rotatable, pressable and slidable along an axis of rotation. The displacement along the axis of rotation can lead to triggering an electrical switch.

DE 103 15 721 A1 also describes a roller-shaped control element. The roller is rotatable and slidable along the axis of rotation. The sliding along the axis of rotation is linked to a sensor to determine the action of force.

Generally, conventional designs include at least the following drawbacks:

Purely mechanical control elements electrically connected as usual meet the requirements of the car manufacturers to some extent only. These requirements, for example, are an enclosed design of the electronic components and water-tight and dust-tight seal achieved thereby, or at least, a water- or dust-insensitive design, as well as low-wear design to achieve a long service life. Because the electronic input unit and the control component are not separated and cannot be enclosed, no or insufficient protection against water possibly penetrating is provided so that there is a risk of an electrical short circuit, as well as no or insufficient protection against penetrating dust is provided, which results in a lower quality and hence service life of the control element.

### SUMMARY

In some aspects, a control unit is provided and includes mechanical control elements for controlling multi-functional systems such that the control unit is protected against water and dust having a long service life.

In other aspects, a control device of a multi-functional system for motor vehicles is provided. The control device includes one or more control elements established moving and/or touch-sensitive, an input unit against that the control element is electrically insulated, the input unit provided with a set of two-dimensional or three-dimensional optical sensors that detects a motion of the control element itself and/or touch actions on the control element, a display unit to represent information in lists by means of which the multi-functional system can be controlled, a computing unit in data connection to the input unit and the display unit, the computing unit converting the positional data of the control element and/or the positional data of the touch on the control element into a corresponding position in a selection list of the display unit, and a switching unit that can be actuated over the control element allowing the selection of a list element.

In further aspects, the opto-electronic input unit and the control component are separated from each other. An optical sensing technology is adapted to separate the detection of the motion of the control element, i.e., a rotary motion and/or a displacement, from the mechanical motion of the control element.

In still other aspects, the control unit can include one or more of the following control elements: A roller that is rotatable, pressable and slidable; rotary actuators or rotary-pressing actuators; a mechanical control plate that is slidable in 4-path directions, 8-path directions or freely movable; an optical detection unit (sensing unit, input unit) to detect finger gestures on a touch-sensitive surface; and a so-called trackball.

In still further aspects, at least one of the control elements is roller-shaped and rotatably supported on a first axis of rotation, and at the same time is pressable into a path direction, wherein a possibly performed rotary motion of the roller-shaped control element is detected by the set of two-dimensional or three-dimensional optical sensors of the input unit and the position, that is the orientation of the roller-shaped control element, is converted by the computing unit into a corresponding position in a selection list of the display unit so that a vertical motion through selection lists of the display element is made possible.

A photo or optical sensor is used to detect the rotation and the left-hand or right-hand motion of the roller that is to ensure a two-dimensional or three-dimensional detection. The roller is electrically insulated from the board, thus also insulated from the live electronic components. Therefore, there are no limitations of the product design caused by a direct connection of the control element to the electronic components. Rather, maximum freedom of the product design is given. Moreover, an ideal protection against humidity and water penetration, or insensitivity thereof is ensured. With the rotary motion optically input, no wear of the input unit is produced.

In yet other aspects, an optimized control of complex menu-based systems is provided. Particularly, the control through a roller-shaped control element is similar to that using the scrolling wheel of the computer mouse implemented in the field of computers.

In yet further aspects, the control element is adapted to slide to the left and right, wherein a slide motion possibly performed of the control element is detected by the set of two-dimensional or three-dimensional optical sensors of the input unit and the position of the control element is converted by the computing unit into a corresponding position in a selection list of the display unit so that a left-hand or right-hand motion through selection lists of the display element is enabled.

In other aspects, a control element is provided with a capacitive surface that enables detection of a swipe motion on the surface of the control element at any position by a capacitive sensor, wherein each position of the control element is converted into a corresponding position in a selection list of the display unit. This enables performance of any swipe motion such as a left-hand or right-hand motion, through selection lists of the display unit.

For pressing, a switch can be actuated mechanically or electronically, wherein for the human user actuation is to be in form of tactile or haptic feedback. Advantageously, tactile switches can be chosen for pressing. The tactile feedback of the switch is exchangeable in order to meet the requirements of various car manufacturers. Also the material of each control element is exchangeable.

Also, a roller-shaped control element offers a one-path press function, for which the roller may require a structure lying underneath. Actuating a switch enables the selection of a list element, with the switch hidden below the surface. The switch can be actuated mechanically or electronically. According to one embodiment, the switching device comprises a switch that is mechanically connected to the first axis of rotation in such a manner that a vertical or horizontal motion of a roller-shaped control element and the first axis of rotation caused by pressing results in triggering the switch. This enables the selection of a list element over a one-path press function of the roller-shaped control element.

Continuing, a first lever arm of a toggle element with two lever arms and a vertex originates from the first axis of rotation, with the toggle element supported at its vertex on a second axis of rotation. The second lever arm of the toggle element originates from the second axis of rotation and, upon a vertical motion of the roller-shaper control element and the first axis of rotation, the second lever arm is moved such that the second lever arm with its facing end contacts the switch thereby triggering the switching action.

In further aspects, the switching device includes an optical or capacitive sensor that triggers the switching action when it detects a vertical or horizontal motion of the roller-shaped control element caused by pressing. Also, in this way, the selection of a list element through a one-path pressing function of the roller-shaped control element is made possible.

### BRIEF DESCRIPTION OF DRAWINGS

Further details, features and advantages of the present invention will become apparent upon reading the following description of exemplary embodiments in conjunction with the accompanying drawings.

FIG. 1 is a front view of an exemplary roller-shaped control element; and

FIG. 2 is a side view of an exemplary design of the roller shown in FIG. 1 using an optical sensor.

### DETAILED DESCRIPTION

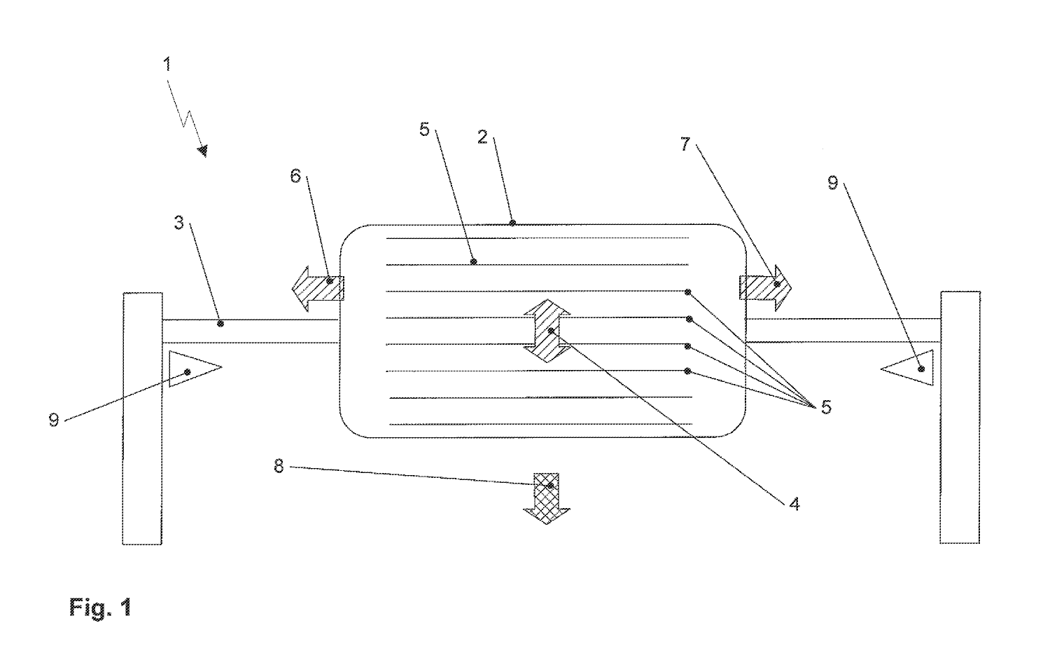

FIG. 1 shows a front view of a part of the control device 1 with a control element 2 shaped as a 4-path roller. The roller-shaped control element 2 is supported on a first axis of rotation 3 in a spring casing (not shown). The rotary motion 4 of the roller-shaped control element 2 on the first axis of rotation 3, shown by the double arrow 4, is used for a vertical motion through lists that are represented at a display element not shown in FIG. 1. The roller-shaped control element 2 is preferably equal or greater than about 40 mm in width and has a diameter of about 20 to 25 mm. In this exemplary embodiment, a surface structure 5 with lines 5 oriented parallel to the first axis of rotation 3 is established on the surface 5 of the control element 2. The lines 5 enable optical detection of the position of the roller-shaped control element 2. In other exemplary embodiments, the control element may not include lines. Further, the roller-shaped control element 2 is left-right movable along the axis of rotation 3, the respective slide motions 6, 7 of the control element 2 in the FIG. 1 are indicated by a left-hand slide arrow 6 or a right-hand slide arrow 7. In some exemplary embodiments, the roller surface 5 can be capacitive and replace a left-hand or right-hand motion. Such a capacitive roller surface 5 may enable a swipe motion on the surface 5 of the roller at any position.

The roller-shaped control element 2 also offers a one-path pressing function 8, indicated by an arrow 8 pointing downwards. For such a pressing function, the roller-shaped control element 2 may include a sub structure (not shown in FIG. 1). Actuating one or more switches 9 through the one-path pressing function 8 enables selection of a list element, with the respective switch 9 hidden below the surface that is visible to the user, of the control element 2. The switch 9 can be mechanically or electronically actuated, wherein for human users the actuation is to be in form of a tactile or haptic feedback.

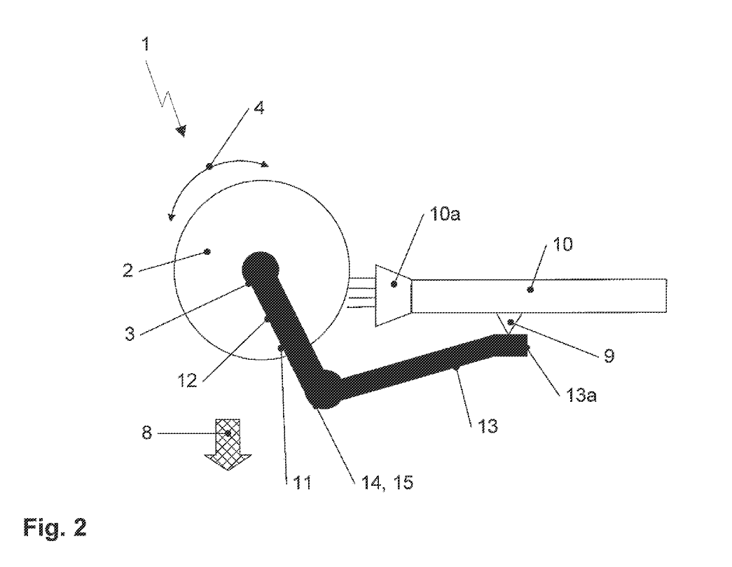

FIG. 2 shows a side view of part of the control device 1 with a roller-shaped control element 2 supported on a first axis of rotation 3 in a spring casing not shown. A two-dimensional or three-dimensional optical sensor 10a (or a two-dimensional or three-dimensional optical sensor system comprising one or more sensors) as part of an input unit 10 detects the rotary motion 4 of the roller-shaped control element 2. For example, a two- or three-dimensional photo sensor like in a computer mouse can be used as part of an input unit 10. Furthermore, FIG. 2 shows a switching device comprising a switch that can be identical to the switch 9 from FIG. 1 or can be based on a different technical base, the switch actuatable over a toggle element 11. A first lever arm 12 of the toggle element 11 with two lever arms 12, 13 and a vertex 14 originates from the first axis of rotation 3. The toggle element 11 is supported at its vertex 14 on a second axis of rotation 15 and the second lever arm 13 originates from the second axis of rotation 15. Upon a vertical motion (downwards) caused by pressing 8 the roller-shaped control element 2 and the first axis of rotation 3, the second lever arm 13 with its facing free end 13a can contact, or press, respectively, the switch 9, thus triggering the switching process. The toggle element 11 can be a cohering component or be comprised of two separate lever arms 12, 13 fixed to the second axis of rotation 15.

### PART NUMBER LIST

1 control device
2 control element
3 first axis of rotation
4 double arrow, rotary motion
5 surface structure (of the roller-shaped control element 2), surface (of the control element 2), oriented lines, roller surface
6 slide motion, left-hand slide arrow
7 slide motion, right-hand slide arrow
8 pressing, one-path pressing function, arrow pointing downwards
9 switch
10 input unit
10a optical sensor, set of optical sensors
11 toggle element
12 first lever arm (of the toggle element 11)
13 second lever arm (of the toggle element 11)
13a free end (of the second lever arm 13)
14 vertex (of the toggle element 11)
15 second axis of rotation

What is claimed is:

1. A control device of a multi-functional system for motor vehicles, the control device comprising:
a control element that is movable and touch-sensitive;
an input unit electrically insulated from the control element, the input unit including a set of optical sensors adapted to detect at least one of motion of the control element and a touch action on the control element;
a display unit adapted to represent information in list form and the information associated with control of the multi-functional system;
a computing unit in data connection with the input unit and the display unit, the computing unit adapted to convert positional data associated with the at least one of the control element and the touch action on the control element into a corresponding position in a selection list of the display unit; and
a switching unit adapted to be actuated and coupled to the control element, the switching unit allowing selection of a list element.

2. The control device of claim 1, wherein the control element is roller-shaped and is rotatably supported on a first axis of rotation in a spring casing, the control element is adapted to be pressed into a path direction, and wherein a rotary motion of the control element is detected by the set of optical sensors of the input unit and a position of the control element is converted by the computing unit into a corresponding position in a selection list displayed on the display unit so that a vertical motion through the selection list displayed on the display unit is made possible.

3. The control device of claim 1, wherein the control element is one of a rotary actuator and a rotary-pressing actuator.

4. The control device of claim 1, wherein the control element comprises a touch-sensitive surface and the set of optical sensors of the input unit is adapted to detect finger gestures on the touch-sensitive surface.

5. The control device of claim 1, wherein the control element is a trackball.

6. The control device of claim 1, wherein the control element is laterally slidable in a first direction and a second direction opposite the first direction, and wherein the set of optical sensors detects sliding motion of the control element and a position of the control element is converted by the computing unit into a corresponding position in a selection list displayed on the display unit so that a first direction hand-motion and a second direction hand-motion through the selection list displayed on the display unit is enabled.

7. The control device of claim 1, wherein the control element includes a capacitive surface enabling detection of a swipe motion on the capacitive surface at any position by a capacitive sensor, and wherein a position of the control element is converted into a corresponding position in a selection list displayed on the display unit so that any swipe motion through a selection list displayed on the display unit is made possible.

8. The control device of claim 1, wherein the control element is a mechanical control plate, and wherein the mechanical control plate is one of slidable in 4-path directions, slidable in 8-path directions, and freely movable.

9. The control device of claim 1, wherein the control element is roller shaped and is rotatably supported on a first axis of rotation, and wherein and the switching unit includes a switch that is mechanically connected to the first axis of rotation such that one of a vertical motion and a horizontal motion of the control element and the first axis of rotation caused by pressing results in triggering the switch so that selection of a list element over a one-path press function of the control element is enabled.

10. The control device of claim 9, further comprising a toggle element including a first lever arm, a second lever arm, and a vertex (14), the first lever arm originating at the first axis of rotation, wherein the vertex of the toggle element is supported on a second axis of rotation and the second lever arm originates at the second axis of rotation (15), and wherein, upon a vertical motion of the control element and the first axis of rotation, the second lever arm with its facing end contacts the switch.

11. The control device of claim 1, wherein the switching unit includes one of an optical sensor and a capacitive sensor that triggers switching action when the one of the optical sensor and the capacitive sensor detects one of a vertical motion and a horizontal motion of the control element caused by pressing of the control element so that a selection of a list element through a one-path pressing function of the control element is made possible.

12. The control device of claim 1, wherein the control element is one of a plurality of control elements.

13. The control device of claim 1, wherein the set of optical sensors are one of two-dimensional optical sensors or three-dimensional optical sensors.

14. The control device of claim 1, wherein the set of optical sensors is adapted to detect both motion of the control element and touch action on the control element.
